(19) United States
(12) Patent Application Publication
(10) Pub. No.: US 2004/0162828 A1
(43) Pub. Date: Aug. 19, 2004

(54) System and methods for monitoring items

(76) Inventors: Jeremy Paul Moyes, Canterbury (GB); Heiko Olaf Haasler, London (GB)

Correspondence Address: Oliff & Berridge, P O Box 19928, Alexandria, VA, 22320, US

(21) Appl. No.: 10/343,713

(22) PCT Filed: Aug. 2, 2001
(86) PCT No.: PCT/GB01/03491

(30) Foreign Application Priority Data
Aug. 4, 2000 (GB) 0019233.6
Apr. 26, 2001 (GB) 0110290.4

(51) Int. Cl. G06F 17/30

(52) U.S. Cl. 707/9

(57) ABSTRACT

A system for monitoring items each carrying a security device including a unique identifier wherein, in use, the items are packaged securely within one another, the system comprising a database for storing data defining each item, the items packaged within it and the items in which it is packaged; and a control system for allowing the database to be updated with new information and to allow remote users to access the database using the unique identifiers so as to read the stored information.

The invention relates to a system and methods for monitoring items.

Across all industries there are supply chain pressures on stock, merging, and parallel “grey market” imports. The increasing pace of change permits the introduction of illegitimate products into the chain, whether this is designer perfumes into discount retail stores, or relabelled out-of-date pharmaceuticals into health services, counterfeit maintenance and service spares into automotive aerospace service centres, or undeclared import of tobacco and liquor from one national tax regime to another.

Typically, at present, valuable items such as software, high value consumables and the like are packaged with tamper evident labels and/or other high security labels so that a purchaser can confirm their authenticity. However, even such genuine products can be fraudulently or otherwise mishandled and the presence of the label is not sufficient to reveal this. For example, a genuine replacement part for a product may be supplied at a time after its “sell-by” date which would not otherwise be apparent to the purchaser.

In accordance with one aspect of the present invention, a system for monitoring items each carrying a security device including a unique identifier wherein, in use, the items are packaged securely within one another comprises a database for scoring data defining each item, the items packaged within it and the items in which it is packaged; and a control system for allowing the database to be updated with new information and to allow remote users to access the database using the unique identifiers so as to read the stored information.

In this aspect of the invention, advantage is taken of the fact that if the items are securely packaged such that it is possible to detect unauthorized tampering, then it is possible to authenticate all the packaged items by reference to the item whose identifier is accessible. Furthermore, as the item is unpacked, further confirmation of authenticity can be obtained by checking that the packaged items are indeed those expected.

In accordance with a second aspect of the present invention, a system for monitoring items each carrying a security device including a unique identifier comprises a database for storing, for each item, information indexed to the respective unique identifier relating to characteristics of the item as it passes along its supply chain; and a control system for allowing the database to be updated with new information and to allow remote users to access the database using the unique identifier so as to read the stored information.

Advantageously, a system according to both the first and second aspects is provided.

In accordance with a third aspect of the present invention, a method of monitoring items using a system according to the first or second aspect of the invention comprises providing to the database data relating to characteristics of the item as it passes along the supply chain; inspecting an item so as to obtain the unique identifier; and obtaining the content of the database corresponding to the unique identifier.

We have devised a new system and method which not only benefits from the use of security devices to provide the unique identifier but enables information to be obtained about the item, such as its history, content or location (within a package) thus enabling purchasers to carry out additional authenticity checks.

It is known for courier companies to provide a database which can be accessed by users to monitor the location of packages carried by the courier. However, this is completely different from the present invention which is concerned with obtaining information about the authenticity of the item, determining the identity of the item, and/or determining the position of the item in the supply chain. The user of the courier system is not concerned with authenticating the package but simply to determine its current location.

Thus, in accordance with a fourth aspect of the present invention, a method of authenticating items using a system according to the first or second aspect of the invention comprises inspecting an item so as to obtain the unique identifier; obtaining the content of the database corresponding to the unique identifier; comparing the obtained information with the current status of the item; and authenticating the item if its current status is consistent with the obtained information.

Thus, if someone is about to purchase an item, he can access the database so as to learn from the stored information the true location of the genuine item. If this is the same as the location from which he wishes to purchase the item, he can be assured that the item is the genuine item. It, however, a different location is indicated then this suggests that the item he is being offered is not genuine.

A similar approach can be used if previously packaged items are unpacked and the sequence of packaging is recorded. It should be noted that an item in this context could include a container for a lorry or ship or even a suitably secured lorry.

The control system could be accessible in a variety of ways via the telephone, cable and the like but conveniently the control system operates a website accessible via the Internet. This makes it very simple for users to access the database.

Typically, the control system is adapted to update the database only if it receives a password. This prevents the database being updated fraudulently although in other cases the database could respond only to data received from certain suppliers which it knows to be genuine when it is requested to update the data.

The data which is stored relating to the passage of the item through the supply chain can take a variety of forms and will typically include the location of the item, the source of the item, characteristics which enable the item to be authenticated and any other features of the item which it may be found useful to store such as life cycle information (use by dates, warranty), handling instructions (max/min temperature) and customer service/contact details.

The security device could be provided directly on the item, for example a laser etched invisible code. In other examples, a secure label defining the unique identifier can be affixed to the item. The labels may be made secure in a number of different ways. They could be tamper evident, for example by including a feature such as a hologram which is irreversibly damaged if any attempt is made to remove the label. In addition, or alternatively, they could be made authenticatable, for example by including any of the many well known authenticity features used already such as covert patterns or indicia, labels that incorporate machine readable holograms using either optical or magnetic features; covert taggents, metamerics, thermochromics or photochromics.

The unique identifier may be visible so that it can be manually supplied to the database but conveniently it is machine readable. This allows the unique identifier to be concealed to the naked eye. The unique identifier could be in the form of a bar code, digital watermark, encrypted pattern, on-product marking, or electronic device such as an RFID chip which can be automatically machine read.

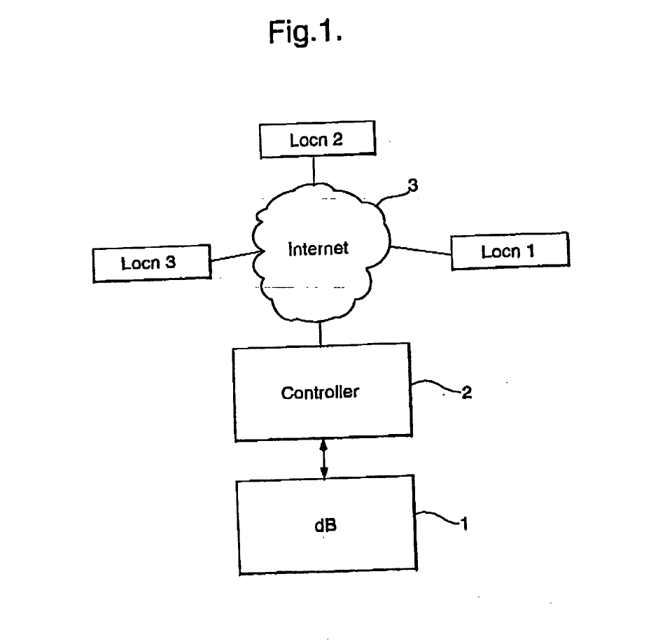

Some examples of systems and methods according to the invention will now be described with reference to FIG. 1 which is a schematic block diagram.

The system shown in FIG. 1 comprises a central database 1 connected to a controller 2 which is able to upload and download data from the database 1. The controller 2 operates a website on the Internet 3 which can be accessed in a conventional manner from many locations of which three labelled “LOCN 1, LOCN 2, LOCN 3” are shown.

In a typical application, the invention is applied to manufactured products. For each product which is manufactured, the controller 2 issues a unique identifier and a set of fields are set up on the database 1 indexed by the unique identifier. Alternatively, the unique identifiers could be provided to the controller 2 from a remote source via the Internet 3. The first approach might typically be adopted by the manufacturer himself when the database is manufacturer specific. The second approach might be used by an organisation separate from the manufacturer, that organisation providing the same service to a number of different manufacturers. The unique identifiers will typically be random or pseudo-random numbers.

The manufacturer obtains or produces a label carrying the unique identifier which he affixes to the product. This label will be tamper evident and authenticatable by including conventional features to achieve these properties. In the preferred approach, the label includes a hologram which can replay the unique identifier and which will be damaged if any attempt is made to remove the label from the item or product.

As the products are packaged and warehoused, the identifiers are scanned and information concerning the description of the product and its source are supplied via the Internet 3 to the controller 2 which stores this information against the corresponding unique identifier in the database 1.

As the products leave each point or node in the supply chain, the unique identifier is scanned and the location information in supplied and stored on the database 1 against the unique identifier. As mentioned above, the controller 2 is preferably programmed to only update information on the database 1 if it receives a password or alternatively receives the information from particular sources known to be genuine. Management of access rights to update certain fields in the database can also be controlled by using digital certificates based on public key infrastructures. This avoids the database from being fraudulently updated.

The database 1 can record the final destinations of the products including consumer ownership and may also record final destruction of the product. Furthermore, waste identifiers will also be recorded, i.e. damaged labels/bar code numbers or the like so should a product be presented with one of these identifiers, it can be easily be identified as fraudulent.

The invention also includes the ability to provide scalability by linking the individual item to a box to a pallet to a batch to a container etc. whereby scanning need only take place once at the highest level to identify contents at all other levels. This would be particularly useful for packaging such as shrink-wrap.

At any time, a supplier/manufacturer/consumer can access the controller website and input a unique identifier so as to retrieve the stored information. In this way, the current condition or location of the product can be verified and authenticated.

In another approach, the database could be loaded in advance with details of the locations through which the item(s) is to be transported through the supply chain. A recipient can then check at each stage whether the item is at its expected location and, if he wishes, further confirm authenticity by looking back at the previous history.

Typically, the label will also have one or more anti-copy features so as to prevent the label being duplicated.

The unique identifier could be recorded very simply with available technology, for example a printed number or a bar code, or alternatively could be recorded by means requiring a special reading device, for example a hologram, a magnetic code etc.

Although the invention is described as having a single Internet web address via which the database can be accessed, it would also be possible to have a separate address corresponding to each unique identifier.

Some specific examples, particularly for authenticating products, will now be described.

### EXAMPLE 1

Replacement service parts e.g. oil filters, brake linings, clutch, exhaust etc. are coded at the manufacturer with a unique holographic signature which is shipped with the part and fixed under the hood of the automobile when it is serviced by a factory authorised dealer. Many months later, the fleet owner or prospective second hand purchaser can have the holograms scanned and by sending the codes to the website can generate a service report which compares the expected usage of such parts with actual placement of genuine factory parts.

### EXAMPLE 2

A hospital pharmaceutical dispensary scan all drugs that are dispensed prior to handing over to doctors/nurses and both the authenticity and the safe date of expiry can be checked online prior to administering. The website can collect an audit trail of when and whom previously performed the check on this item. This example can easily be extended to manufacturing production lines, providing wholesalers, retailers and consumers with an independent verification that a PC does contain a certain chip, or certain software or certain game.

### EXAMPLE 3

A high value watch or high value clothes are sold via a web based auction site, delivered via international parcel carrier and local postal service, returned as the wrong size, then resold overseas. Each purchaser or handler can check the label against the web address for the correctness and history. Government applications could include automobile registration.

As an extension to this operation, it may also be beneficial as an additional facility to keep a record of previous date/person who checked authenticity and to issue a revised number each time authenticity was checked or when the part was first fitted to a car/plane then destroy/cancel the initial number, so it can't be duplicated.

### EXAMPLE 4

40,000 football shirts are discovered in Madagascar. The supplier doer not have an authorised distribution channel in Madagascar and therefore has no idea where these products have come from. By using the new system, the supplier can check on the database the last significant movement of that product, where it has come from and whether it is genuine or not.

### EXAMPLE 5

A man finds an apparently high value watch in a back street jeweller at a very cheap price. The chances are, the man would not buy the watch. However, using his mobile phone he can access the database and enter the unique identifier with the watch and find out the last significant movement of that product, where it has come from and whether it is genuine or not.

### EXAMPLE 6

A crate of Whiskey is being sold cheap in a supermarket in country A. By checking the unique identifier against the database, a purchaser could find out that that crate was supposed to be at a distributor in country B.

### EXAMPLE 7

Inspectors find some crystal glass in a retailer and check the unique identifier against the database. The number may not exist on the database or there way be no audit trail proving the product to be counterfeit.

### EXAMPLE 8

A counterfeiter may be able to guess a valid supplier unique identifier and apply it to counterfeit product. A prospective purchaser or inspector would enquire of the database and find no audit.

### EXAMPLE 9

A counterfeiter may guess or copy a unique number. However, the controller 2 is preferably adapted to trigger an alarm if it receives multiple enquiries from different sources for the same number.

### EXAMPLE 10

A supplier has seen product recorded as having left a distribution node but has not seen it received either in a timely manner or at all.

### EXAMPLE 11

An inspector is visiting a bar and checks on the unique identifier of half full bottles of spirit. The returned information from the database says that that bottle reached its destination four years previously. This could indicate that the bottle may have been refilled (several times).

### EXAMPLE 12

A potential buyer could elect to buy an item from a retailer on the Internet. The retailer would give the buyer the unique identifier of the product and the buyer would go to the database and check on the audit history of the product. It will tell the buyer where that product should be (location), it will give a full history of movement through the supply chain and verify that it got there by an authorized route (validation) and tell the buyer that it is a genuine product (authentication). The buyer can then decide more informatively whether or not to proceed with the purchase.

Other examples include the ability for a tax inspector to check on import/export duties having been paid while a consumer can register final ownership of a product. The unique identifier could also be linked with life cycle information such as service logs/sell-by dates/parts replenishment programs and the likes.

1. A system for monitoring items each carrying a security device including a unique identifier wherein, in use, the items are packaged securely within one another, the system comprising a database for storing data defining each item, the items packaged within it and the items in which it is packaged; and a control system for allowing the database to be updated with new information and to allow remote users to access the database using the unique identifiers so as to read the stored information.

2. A system for monitoring items each carrying a security device including a unique identifier, the system comprising a database for storing, for each item, information indexed to the respective unique identifier relating to characteristics of the item as it passes along its supply chain, and a control system for allowing the database to be updated with new information and to allow remote users to access the database using the unique identifier so as to read the stored information.

3. A system according to claim 1 and claim 2.

4. A system according to any of claims 1 to 3, wherein the control system operates a website accessible via the Internet.

5. A system according to any of claims 1 to 4, wherein the control system is adapted to update the database only if it receives the data from a genuine source and/or with a password, and/or authorised by a digital certificate.

6. A system according to any of the preceding claims, further comprising a plurality of secure labels to be affixed to respective items, each label defining a unique identifier.

7. A system according to claim 6, wherein the labels are tamper evident.

8. A system according to claim 6 or claim 7, wherein the labels are authenticatable.

9. A system according to any of claims 6 to 8, wherein the labels include at least one anti-copy feature.

10. A system according to any of the claims 6 to 9, wherein the unique identifier is recorded on or in the label in a concealed manner.

11. A system according to claim 10, wherein the unique identifier is recorded in a hologram.

12. A system according to any of the preceding claims, wherein the unique identifier is recorded in a manner which is not visible to the naked eye.

13. A system according to any of the preceding claims, wherein the unique identifier is machine readable.

14. A system according to any of the preceding claims, wherein the unique identifier comprises a bar code.

15. A system according to any of the preceding claims, wherein the unique identifier is encrypted.

16. A method of monitoring items using a system according to any of the preceding claims, the method comprising providing to the database data relating to characteristics of the item as it passes along the supply chain; inspecting an item so as to obtain the unique identifier; and obtaining the content of the database corresponding to the unique identifier.

17. A method of authenticating items using a system according to any of claims 1 to 15, the method comprising inspecting an item so as to obtain the unique identifier; obtaining the content of the database corresponding to the unique identifier; comparing the obtained information with the current status of the item; and authenticating the item if its current status is consistent with the obtained information.

18. A method according to claim 16 or claim 17, wherein the information stored in the database defines the expected location of the item as it passes along the supply chain.

19. A method according to any of claims 16 to 18, wherein the information stored in the database provides details about the content of the item.

20. A method according to claim 19, wherein the item contains one or more further items each including a respective identifier, the database storing data defining the relationship between the items.
